(19) United States
(12) Patent Application Publication
(10) Pub. No.: US 2015/0158461 A1
(43) Pub. Date: Jun. 11, 2015

(54) MOTOR VEHICLE ALARM SENSOR

(71) Applicant: Hippi, LLC, Clermont, FL (US)

(72) Inventor: Brian K. HESS, Westerville, OH (US)

(73) Assignee: Hippi, LLC, Clermont, FL (US)

(21) Appl. No.: 14/103,318

(22) Filed: Dec. 11, 2013

(51) Int. Cl. B60R 25/40; B60R 25/32

(52) U.S. Cl. CPC B60R 25/40; B60R 25/32

(57) ABSTRACT

A portable alarm system for a motorcycle or similar motor vehicle. The portable alarm system includes at least one transceiver, a rechargeable power source and at least one accelerometer.

### CROSS-REFERENCE TO RELATED APPLICATIONS

This application claims priority to U.S. Provisional Application No. 61/735,329 filed on Dec. 12, 2012, the contents of which are incorporated by reference herein in its entirety.

### BACKGROUND

Alarm systems for vehicles, motorcycles or all-terrain vehicles have historically utilized a connection with and require the use of the vehicle's battery system. However, such a connection may result in the alarm system being easily dismantled or rendered in-operable from a dead battery. Additionally, these alarm systems must be hard-mounted to the vehicle and fail to provide any interchangeability between other platforms that an operator would want to protect. Thus, there is a need for a portable alarm system, which is easily concealable and contains its own battery and charging system.

### SUMMARY

A portable alarm system for on-highway and off-highway motor vehicles is disclosed. The portable alarm system is a stand-alone unit that contains its own battery system and is capable of recharging through a plurality of methods. The portable alarm system is compact and easily concealable within the outer confines of the vehicle.

The alarm system includes an anti-jamming function, as well as the capability to communicate over various known data packets, such as but not limited to cellular, CDMA, SMS, GSM, MMS, GPRS over various networks, which include, but are not limited to wireless, email/internet networks, PSTN/voice networks, and or paging networks.

In use, the portable alarm system is concealed on the motor vehicle and if the vehicle is moved or attempted to be stolen a silent alarm signal is sent to a handheld device warning the owner of a potential theft. The signal may also be sent to a monitoring station for dispatching a public service officer to the location of the alarm. Additionally, the portable alarm system may include a GPS transceiver to track the motor vehicle, as needed. The alarm system may also include visual and/or audible alert, such as a siren or flashing light.

### DRAWINGS

The drawings described herein are for illustrative purposes only of selected embodiments and not all possible implementations, and are not intended to limit the scope of the present disclosure.

FIG. 1 is an illustration of an embodiment of the portable alarm of the present invention.

Corresponding reference numerals indicate corresponding parts throughout the several views of the drawings.

### DETAILED DESCRIPTION

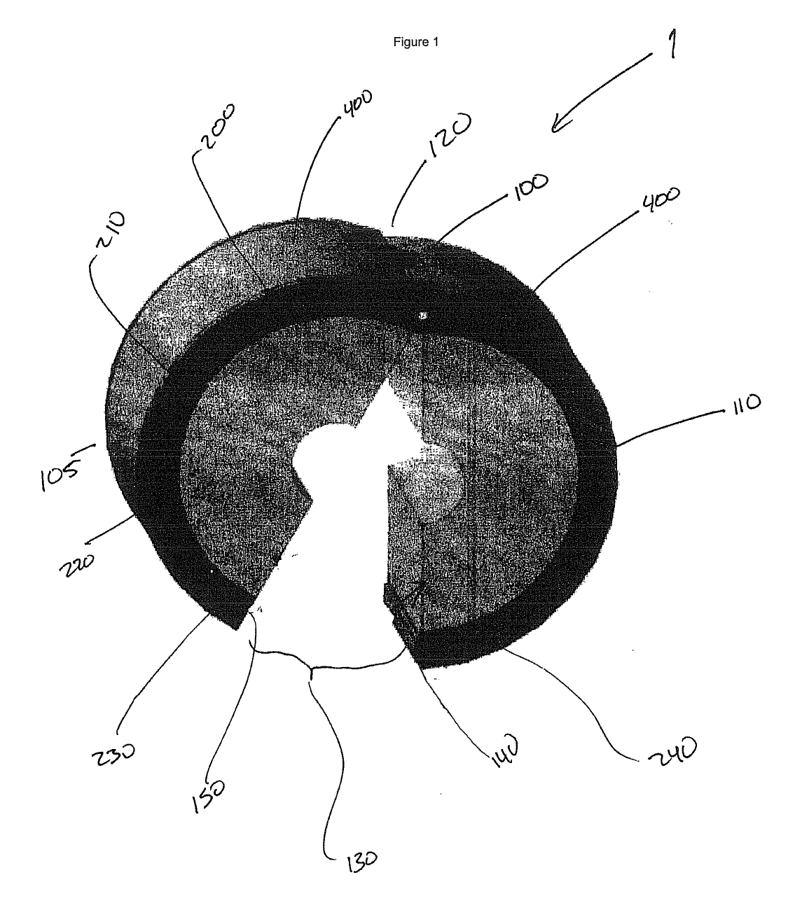

FIG. 1 illustrates an embodiment of the portable alarm system 100 for a motor vehicle, such as a motorcycle or other on-highway or off-highway motor vehicle. The portable alarm system 1 is an integrated two-piece ring 100 that includes a hinge 120 and a connecting portion 130. The ring 100 is comprised of a first half 105 and a second half 110. The connecting portion 130 includes a rare earth magnet 140 on one end and a steel plate 150 on the other end. When the steel plate 150 is brought into proximity of the rare earth magnet 140, the attraction between the plate 150 and the magnet 140 pulls the hinged ring shut and maintains it in a closed configuration.

The first half 105 of the ring 100 integrates various electronic components that enable the alarm system to operate. Included in the first half 105 is an electronic processor and a Hall effect sensor to detect when the steel plate 150 is moved away from the magnet 140. The Hall effect sensor communicates with the electronic processor, which in turn communicates with an electronic transceiver that communicates wirelessly with a monitoring station or mobile electronic device. The first half 105 includes a GPS unit in communication with the processor. The alarm system 1 includes a battery integrated into the first half 105 of the ring 100. The battery is charged by solar panels 400. The first half also includes status indicators 200, 210 and 220, which provide visual information to a user concerning cellular connection, power status and status of the alarm system. The first half 105 also includes a loop port 230 to which an electrical wire may be connected to create a secondary electrical current loop.

The second half 110 of the ring integrates a rechargeable battery inside of the second half 110, as well as a charging port 240. The second half 110 also includes a solar panel to recharge the battery.

The first and second halves 105 and 110 rotate about the hinge 120 so as to wrap around and attach to the handle bars or other portion of a motorcycle or other similar motor vehicle. The portable alarm system may also include a screen that is capable of being flipped up and being upright regardless of position of unit.

An accelerometer may be included that when tilted sends an alarm signal. The system may include various charging capabilities, such as, but not limited to solar, replaceable/rechargeable batteries or common automotive or household power charger cord, including, but not limited to a cigarette lighter or wall plug. The power may be able to receive AC or DC depending on the application. The system may include the ability to removably connect the unit to the motor vehicles electrical system for charging or to provide a kill switch. The motor vehicle may include a receiver cradle that allows the portable alarm system to be dropped into and removed as needed. The batteries may include the ability to stay charged for several hours.

The system may be computer controlled with a portable battery powered radio. Activation of the system may include the ability to have a delayed entry with deactivation with one for activation or deactivation 10 seconds or 20 seconds.

A biometric activation/deactivation element may be included, which allows the operator to turn the unit on or off with the use of a finger print. The unit may include a data pack for alerting the owner to a low battery signal.

The system is equipped with a Bluetooth or similar wireless communication technology to permit users to utilize their cell phone to arm/disarm the alarm.

The system includes a GPS tracking technology. The GPS technology may be powered by a separate power source, such as a second battery, which is selectively activated by the user when the protected asset is to be tracked. Further, the user may have an account with a service provider wherein a fee is charged to track the protected asset only when the GPS technology is activated.

The system will be configured to be housed in and/or by a hinged ring-like mechanism, as shown in FIG. 1, that could clamp to the handlebars or frame of a motorcycle.

In use, the alarm system 1 is attached to a structure of the motorcycle or similar motor vehicle and the connecting portion 130 is closed so that the magnet 140 and the steel plate 150 attract each other and hold the connecting portion 130 closed. The portable alarm system is concealed on the motor vehicle and if the vehicle is moved or attempted to be stolen, the accelerometer detects movement of the motor vehicle, communicates with the processor, which causes the transceiver to send a silent alarm signal to a handheld electronic device, such as a cell phone, warning the owner of a potential theft. The signal may also be sent to a monitoring station for dispatching a public service officer to the location of the alarm. The GPS unit may be used to track the vehicle, as needed. The alarm system may also include visual and/or audible alert, such as a siren or flashing light.

It will be appreciated that the system and methods described herein have broad applications. The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. In accordance with the provisions of the patent statutes, the principles and modes of operation of this invention have been explained and illustrated in exemplary embodiments.

It is intended that the scope of the present methods and apparatuses be defined by the following claim. However, it must be understood that the exemplary embodiments may be practiced otherwise than is specifically explained and illustrated without departing from its spirit or scope. It should be understood by those skilled in the art that various alternatives to the embodiments described herein may be employed in practicing the claim without departing from the spirit and scope as defined in the following claim. The scope of the disclosure should be determined, not with reference to the above description, but should instead be determined with reference to the appended claim, along with the full scope of equivalents to which such claim is entitled. It is anticipated and intended that future developments will occur in the arts discussed herein, and that the disclosed systems and methods will be incorporated into such future examples. Furthermore, all terms used in the claim are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claim defines the scope of the disclosure and that the method and apparatus within the scope of this claim and its equivalents be covered thereby. In sum, it should be understood that the exemplary embodiment is capable of modification and variation and is limited only by the following claims.

What is claimed is:

1. A self-contained removable portable alarm system, comprising:
an attachable housing;
a processor integrated into the housing;
a transceiver and an accelerometer integrated into the housing and in communication with the processor; and
a rechargeable power source integrated into the housing.
